(19) United States
(12) Patent Application Publication
(10) Pub. No.: US 2026/0310510 A1
(43) Pub. Date: Oct. 8, 2026

(54) METHODS AND APPARATUS FOR FEDERATED LEARNING CLIENT REGISTRATION, DISCOVERY AND SELECTION SERVICES

(71) Applicant: InterDigital Patent Holdings, Inc., Wilmington, DE (US)

(72) Inventors: William Robert Flynn, IV, Schwenksville, PA (US); Lu Liu, Conshohocken, PA (US); Quang Ly, North Wales, PA (US); Dale Seed, Allentown, PA (US)

(73) Assignee: InterDigital Patent Holdings, Inc., Wilmington, DE (US)

(21) Appl. No.: 19/482,961

(22) PCT Filed: May 9, 2024
(86) PCT No.: PCT/US2024/028502

§ 371 Date: Nov. 10, 2025

Related U.S. Application Data
(60) Provisional application No. 63/501,513, filed on May 11, 2023.

(51) Int. Cl. G06F 9/50; G06N 3/098

(52) U.S. Cl. CPC G06F 9/5027; G06N 3/098

(57) ABSTRACT

Methods, apparatus, and systems are described for improved federated learning (FL) service used for training of machine learning models. In some examples, an improved FL service may allow FL clients to register to the FL service. The FL service may provide methods for discovery and selection of FL clients by FL users.

### CROSS-REFERENCE TO RELATED APPLICATIONS

This application claims the benefit of U.S. Provisional Patent Application No. 63/501,513, filed May 11, 2023, which is hereby incorporated by reference in its entirety.

### BACKGROUND

Machine learning (ML) is the process of providing data for a specific application to train an algorithm or model to learn of desired behaviors for use in future inferencing. The process includes identifying data for the application, collecting and preparing the data, training an algorithm or model with the clean data, validating and testing the trained model, deploying the model for inferencing, and monitoring the operations of the model.

Federated learning (FL) is an approach to ML in which an FL server manages the training of an ML model through the utilization of multiple FL clients. Data privacy is an important aspect of federated learning and therefore data are kept locally at the individual clients. As a result, data confidentiality is preserved at the individual clients but the desired machine learning application may still be achieved through the training of a model with the federated learning clients. FL training is performed through many rounds in which the ML model, model parameters, and associated training parameters are communicated from the FL server to the FL clients at the beginning of each round and the FL clients provide the model update (including model weights) to the FL server after training has completed for the round. The FL server aggregates the model weights, updates the global model, and the training repeats for the next round with the updated global model.

### SUMMARY

Described herein are methods, apparatus, and systems for improved federated learning (FL) service. According to some examples, an FL service may allow FL clients to register to the FL service. The FL service may provide methods for discovery and selection of FL clients by FL users. In one example for registration of an FL client with an FL service, an apparatus may send, to a server associated with a federated learning (FL) service, a first message indicating a request to register with the FL service, wherein the message indicates an availability of one or more datasets, a machine learning (ML) application applicable to the one or more datasets, a data count, and a list of one or more features associated with the one or more data sets. The first message may further indicate at least one of: one or more dataset types, a dataset provider, an application identifier, a service identifier, a dataset identifier, a dataset description, a target feature, a label description, a feature name, a format, metadata, a feature identifier, one or more related features, or sample data. The apparatus may send, to the server, a second message indicating one or more capabilities, associated with the apparatus, comprising at least one of: a type of CPU used for ML training, a type of GPU used for ML training, and an amount of memory available to perform FL. The second message may further indicate at least one of: an operating system, a processing script capability, or one or more communication protocols. The apparatus may send, to the server, a third message indicating a schedule for performing FL. The apparatus may send, to the server, a connection message comprising an FL client identifier indicating information to identify or address the apparatus. The FL client identifier may further indicate a location for data storage associated with the apparatus.

In another example, an FL service may receive a request from an FL client to register to the FL service and to store the received information within an FL service resource. The FL service may receive a request from an FL user to discover one or more FL clients, process the request and send a discovery response and/or notification to the FL user. The FL service may receive a request from an FL user to select one or more FL clients to participate in an FL operation. The FL service may monitor FL client status and dynamically select clients participating in federated learning (to further maintain privacy/anonymity). The FL service may receive the FL client status and progress of a client performing federated learning training. The FL service may notify a user of changes in client states during federated learning training. The FL service may schedule/share processing time on the client. The FL service may update client selection based on client status updates and one or more policies defined by the FL user. The FL service may send an FL user a notification of clients selected for a new training round.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1 shows an example of a Federated Learning Training Round;

FIG. 2 shows an example of FL Client and Data Registration;

FIG. 3 shows an example of FL Client Discovery;

FIG. 4 shows an example of FL Client Selection;

FIG. 5 shows an example of a RESTful example of Federate Learning Discovery Service;

FIG. 6 shows an example of FL client registration and discovery;

FIG. 7 shows an example of FL Client Provisioning with FL Client known a priori;

FIG. 8 shows an example use of Discovery and Selection policies;

FIG. 9 shows an example of FL Client Selection and Reselection;

FIG. 10 shows an example FL Client Registration Graphic User Interface (GUI);

FIG. 11 shows an example Feature Registration GUI;

FIG. 12 shows an example Compute Capabilities Registration GUI;

FIG. 13 shows an example FL Client Discovery and Selection GUI;

FIG. 14A illustrates an example communications system;

FIGS. 14B, 14C, and 14D are system diagrams of example RANs and core networks;

FIG. 14E illustrates another example communications system;

FIG. 14F is a block diagram of an example apparatus or device, such as a WTRU; and

FIG. 14G is a block diagram of an exemplary computing system.

### DETAILED DESCRIPTION

The following definitions and abbreviations are described herein as shown in Table 0.1.

TABLE 0.1
Abbreviations

| | |
|---|---|
| 3GPP | Third Generation Partnership Project |
| DNS | Domain Name Service |
| FQDN | Fully Qualified Domain Name |
| FL | Federated Learning |
| ML | Machine Learning |
| RDF | Resource Description Framework |
| REST | Representational State Transfer |
| URL | Uniform Resource Locator |

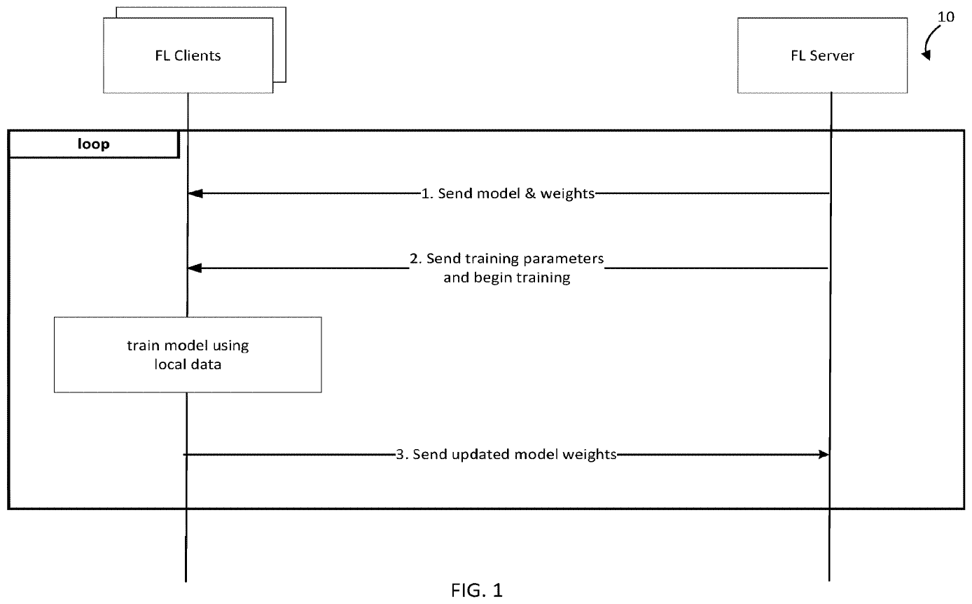

FIG. 1 shows an example 10 of a federated learning training round between an FL server and multiple FL clients. In each training round, an FL server may provide an ML model to each FL client accompanied with the associated model weights and training parameters. The FL clients may train the ML model with local data and send the updated model weights to the FL server for aggregation. The training may repeat until one or more performance objectives are met.

For example, at step 1, the FL server may send a model and weights to one or more FL clients. At step 2, the FL server may send training parameters to the one or more FL clients and begin training the one or more FL clients. At step 3, the one or more FL clients may send updated model weights to the FL server.

FL services may not be not capable of allowing FL clients to register and share FL client information such as compute capabilities, schedule of availability, and data availability. Moreover, current FL services are not capable of allowing FL users to query, discover and select FL clients to be used to train machine learning models in a federated manner. As a result current FL deployments tend to rely upon pre-existing relationships and pre-provisioning of information such as network addresses, pre-selected FL clients for FL training, and the chosen data set. This lack of advanced FL services may restrict the types of use cases in which FL can be applied, may add complexity to deploying and managing FL, and hence may prevent wide scale adoption and use of FL in commercial deployments.

For example, many cities around the world are trying to offer advanced services to their citizens and visitors through Smart City initiatives. One common offering is open datasets that can be used to develop applications. This open data is generally made available to users through a cloud portal where users can download the data and apply custom business logic to create applications.

Cities are not able to open all of their data to customers because some data may contain personal identifiable information. For example, images captured at traffic lights may have sufficient resolution to identify a person and location. Data of this nature may be useful for machine learning applications if it can be shared in a privacy preserving manner. Federated learning is a suitable solution to support privacy preservation for machine learning applications, however configuring a federated learning environment requires explicit coordination between the clients that have data and the server that is training a machine learning model.

Solutions to one or more of the aforementioned problems are described herein. For example, an FL service may allow FL clients to register to the FL service. The FL service may provide methods for discovery and selection of FL clients by FL users.

In an example, an FL service may receive a request from an FL client to register to the FL service. The request may include one or more of the following information elements: compute capabilities which the FL client has available for federated learning; scheduled availability of the FL client to perform federated learning tasks; authorized FL users of the FL client; information regarding datasets and/or features on the FL client available for use by federated learning; and/or ability to run multiple federated learning processes in parallel. The FL service may store the received information within an FL service resource.

In an example, an FL service may receive a request from an FL user to discover one or more FL clients. The request may include one or more of the types of FL client discovery criteria. The FL client discovery criteria may include one or more of the following elements: FL client dataset description; FL client identifier list; FL training time window; and/or FL client compute capabilities. The request may include a policy for federated learning client discovery. The FL service may process the request by comparing the FL client discovery criteria in the request against FL client information stored by the FL service to determine matching FL clients. The FL service may send a discovery response and/or notification to the FL user. In an example, the response may comprise one or more of the following information elements: a list of FL client IDs matching the FL client discovery criteria; a list of datasets that are available on the FL clients; and/or an FL client discovery pool ID.

In an example, an FL service may receive a request from an FL user to select one or more FL clients to participate in an FL operation. The request may include one or more of the following types of information elements: a list of FL client IDs to be included in an FL training round; a training time window defining a deadline for when FL training is to be completed; and/or an FL client selection policy comprising one or more of the following information elements: minimum and/or maximum number of FL clients; a selection policy criteria; and/or desired FL client characteristics. The FL service may monitor federated learning client status and dynamically select clients participating in federated learning (to further maintain privacy/anonymity). The FL service may receive the status and progress of a client performing federated learning training. The FL service may notify a user of changes in client states during a federated learning training round. The FL service may schedule/share processing time on the client. The FL service may update client selection based on status updates and policy defined by the FL user. The FL service may send the FL user a notification of clients selected for new training round.

In an example, an FL service may allow FL clients to register to the FL service. The FL service may provide methods for discovery and selection of FL clients by FL users. In an example, the FL service may enable more efficient and scalable FL techniques to be used for training machine learning models using federated learning concepts. In some examples, these procedures may be used for non-machine learning processes that are intended to process data at the edge or other remote clients without transmitting or sharing the full dataset.

In machine learning it may be important that data is prepared or processed so that it is consistent with the expected formats needed for the machine learning model. In an example, it may be assumed that the FL client data format is acceptable to the FL user or that other procedures are used to process the FL client data so that it is acceptable for the user's machine learning model.

The following terms may be used herein to identify the actors involved with federated learning:

A Federated Learning Client (FL client) may identify a network apparatus (e.g., device, gateway or server) hosting compute, memory and network connectivity resources capable of hosting an FL client (e.g., client application) which registers to an FL service and also hosts local data that may be used for training machine learning models in a federated manner;

A Federated Learning User (FL user) may identify a user apparatus (e.g., computer, smart phone, tablet) hosting compute, memory and network connectivity resources capable of hosting a user application (e.g., web browser, app) which a user uses to perform FL centric operations with an FL service such as but not limited to discovery and selection of available FL clients. An FL user could also be the owner of one or more FL clients; and

A Federated Learning Service (FL service) may identify a network apparatus (e.g., device, gateway or server) hosting compute, memory and network connectivity resources capable of hosting an FL service which performs FL management operations such as FL client registration, discovery and selection.

The techniques described herein may include one or more of the following processes: a process for an FL client to register to an FL service and make its data available to users for machine learning; a process for an FL user to discover, via an FL service, FL clients that have data available for training a machine learning model; and/or a process for an FL service to select one or more FL clients to perform an FL training process based on criteria such as the data FL clients have available and/or requirements specified by FL users.

An FL service may support a registration process that allows one or more FL clients (e.g., which has data available for FL training) to register information about the available data and the capabilities of the FL client to facilitate training of the data. The registration process may be initiated by the FL clients sending a registration request to the FL service. In an example, another entity (e.g., the owner of the FL clients) may perform a registration of the FL client(s) with the FL service. For cases where multiple FL clients are registered, a bulk registration may be performed by the owner of the FL clients.

An example is described below for registration of an FL client with an FL service. In an example, an apparatus may receive, from a federated learning (FL) client, one or more messages indicating a request to register with an FL service associated with the apparatus, wherein one or more messages may indicate an availability of one or more datasets, a data count, and a list of one or more features associated with the one or more data sets. The one or more messages may further indicate at least one of: a machine learning (ML) application applicable to the one or more datasets, one or more dataset types, a dataset provider, an application identifier, a service identifier, a dataset identifier, a dataset description, a target feature, a label description, a feature name, a format, metadata, a feature identifier, one or more related features, sample data, or a schedule for performing FL. The one or more messages may indicate one or more capabilities, associated with the FL client, comprising at least one of: a type of CPU used for FL training, a type of GPU used for FL training, and an amount of memory available for FL training. The one or more messages may further indicate at least one of: an operating system, a processing script capability, or one or more communication protocols. The apparatus may receive, from the FL client, a connection message comprising an FL client identifier indicating information to identify or address the FL client. The FL client identifier may further indicate a location for data storage associated with the FL client.

In another example, an apparatus may send to a server associated with a federated learning (FL) service, one or more messages indicating a request to register with the FL service. The one or more messages may indicate an availability of one or more datasets, a data count, and a list of one or more features associated with the one or more data sets. The one or more messages may further indicate at least one of: a machine learning (ML) application applicable to the one or more datasets, one or more dataset types, a dataset provider, an application identifier, a service identifier, a dataset identifier, a dataset description, a target feature, a label description, a feature name, a format, metadata, a feature identifier, one or more related features, sample data, or a schedule for performing FL. The one or more messages may indicate one or more capabilities, associated with the apparatus, comprising at least one of: a type of CPU used for FL training, a type of GPU used for FL training, and an amount of memory available for FL training. The one or more messages may further indicate at least one of: an operating system, a processing script capability, or one or more communication protocols. The apparatus may send, to the server, a connection message comprising an FL client identifier indicating information to identify or address the apparatus. The FL client identifier may further indicate a location for data storage associated with the apparatus.

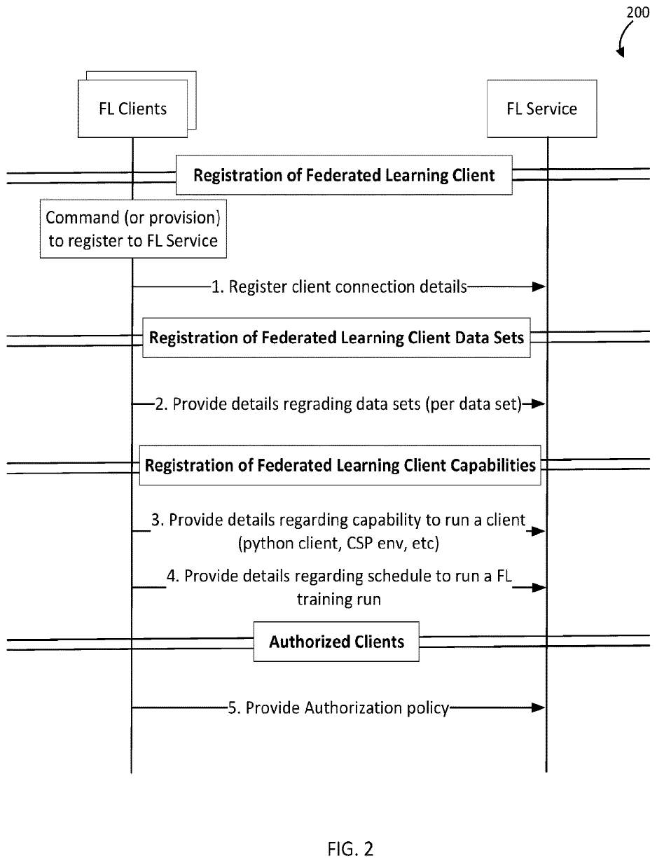

FIG. 2 shows an example registration procedure 200 for the registration of FL clients with an FL service. In an example, a prerequisite step to this procedure may be to provision an FL client with contact information (e.g., network address, port, location) of the disclosed FL service and an event to trigger the FL client to register to the Federate Learning Service.

At step 1, an FL service may receive an FL client connection message from an FL client (or another entity in the system) including information needed for an FL service to communicate with the FL client. This information may be used by the FL service to communicate with the FL client that it has been selected for federated learning using the FL client's available data and other informational elements defined below. Rather than a separate FL client connection message, this information may be included within one or more of the other messages described herein. An example of the FL Client Connection Message is shown in Table 1.

TABLE 1
FL Client Connection Message

| Informational | |
|---|---|
| Element | Parameter Description |
| Federate | An IP address and port number, an FQDN, a DNS name, |
| Learning | or other unique address for establishing communication |
| Service | with the FL service. This may include communication |
| Connection | protocols such as http(s), mqtt(s), etc. |
| Details | |
| FL client | An identifier that is used to uniquely identify and/or |
| identifier | address this FL client. It can also be used for other FL |
| | service features such as determining where to store data |
| | related to this FL client. |
| Authorization/ | Credentials used to authorize and authenticate a FL |
| Authentication | client such as a security token, preshared key or |
| | security certificates. |
| Target URL | Base or target URL for messages from this FL client to |
| | the FL service. |
| Callback | An address where the FL service should send messages |
| endpoint | targeting the FL client. Examples include and IP address |
| | and port and/or target uri where the FL client can directly |
| | receive messages. |

At step 2, an FL service may receive a feature registration message from an FL client (or another entity in the system) which includes information regarding the datasets that the FL client has or will have available for training a machine learning model. The message may include details about the content and format of the datasets as well as relevant metadata, when it exists, such as a timestamp or location. The message may also include qualitative metrics about the dataset that indicate quantity and distributions of labels in the dataset, if available. Rather than a separate FL client feature registration message, this information may be included within one or more of the other messages described herein. An example of the FL Client Feature Registration Message is shown in Table 2.

TABLE 2
FL Client Feature Registration Message

| Informational | |
|---|---|
| Element | Parameter Description |
| Number of | Total number of datasets available on the FL |
| available datasets | client |
| Dataset types | List of the types of datasets that are available |
| | on the FL client |
| Dataset | An identifier of the dataset provider or owner |
| provider/owner | of the dataset |
| Application ID | An identifier of an application associated with |
| | the dataset |
| Service ID | An identifier of a service or service provider |
| | associated with the dataset |
| Dataset identifiers | List of identifiers for datasets available on the |
| | FL client |
| >ML application | Identifies the type of ML application the dataset |
| type | may apply to |
| >Description | A description of the dataset. This can be human |
| | readable description or using a description syntax |
| | such as RDF. It can include qualitative descriptions |
| | and quantitative descriptions. For example: |
| | “images from traffic cameras at intersection 1^{st} |
| | and main st” |
| | “cars, trucks, motorcycles, etc” |
| >Target feature | Identifies a feature within the dataset where |
| | labels are available |
| >Label distribution | Provides a distribution of the labels |
| >Data Count | The number of instances of this dataset that are |
| | available. |
| >List of features | List of features that the dataset contains |
| >>Feature Name | A name that describes a particular feature |
| >>Format | The format/schema of the feature. For example, |
| | “image size: 1080 × 780” |
| | “colors: 8 bit, etc” |
| | “temperature: degrees Celsius an an integer” |
| >>Metadata | Descriptive information of the feature. For example, |
| | “distance from camera: 50 ft” |
| >>Feature ID | An identifier for feature in the dataset. |
| >>Related Features | Identifier of additional features associated with |
| | this feature. For example a timestamp or location |
| | that indicates where and when the feature was |
| | collected. |
| >Sample Data | One or more examples of this data that the FL client |
| | optionally shares. |

At step 3, an FL service may receive an FL client compute capabilities message from an FL client (or another entity in the system) which includes relevant compute capabilities of the FL client. The compute capabilities may indicate whether the FL client can support processing needs for training a machine learning model provided by a user. Rather than a separate FL client compute capabilities message, this information may be included within one or more of the other messages described herein. An example of the FL Client Capabilities Message is shown in Table 3.

TABLE 3
FL Client Capabilities Message

| Informational | |
|---|---|
| Element | Parameter Description |
| Operating | The operating system that the FL client is running. |
| System | This information may indicate what capabilities |
| | or requirements exist for the ML training that |
| | can be executed by this FL client |
| CPU | Type of CPU that the FL client uses for ML training. |
| | For example: “ARM”, “x86”, “32 bit”, “64 bit”, |
| | etc. Additional examples of information that may |
| | be listed include specific processor models, |
| | clock speed of the processors, or number of |
| | cores available. Alternatively, this information |
| | element may comprise current available CPU MIPS |
| | that the FL client has available to perform FL. |
| GPU | Type of GPU that the FL client uses for ML training. |
| | Alternatively, this information element may |
| | comprise current available GPU MIPS that the FL |
| | client has available to perform FL. |
| Memory | Amount of memory installed on a FL client or |
| | currently available on the FL client to perform FL. |
| processing | Indicates the format of custom scripts for processing |
| script | the data. For example the FL client may require the |
| capability | user to provide a python script to input the FL |
| | client's data to the training or another option |
| | could be use of a docker container that will train |
| | the user's model. Alternatively this could specify |
| | the machine learning framework available on the FL |
| | client and the order of the inputs to the machine |
| | learning model. |
| Communication | A list of the protocols that can be used to |
| Protocols | communicate with the FL client. Examples include |
| | WiFi, LoraWan, 3GPP, Bluetooth, etc. |

At step 4, an FL service may receive an FL client availability schedule message from an FL client (or another entity in the system) which comprises FL client availability information. This message may indicate the times that the FL client may be available to train a machine learning model using the data that it is making available. Rather than a separate FL client training availability message, this information may be included within one or more of the other messages described herein. An example of the FL Client Training Availability message is shown in Table 4.

TABLE 4
FL Client Training Availability message

| Informational | |
|---|---|
| Element | Parameter Description |
| Availability | The times when the FL client is available to perform FL. |
| Schedule | For example, a description of the days and times that the |
| | FL client is available to perform ML training of a model. |

At step 5, an FL service may receive an FL Client Authorization Policy message from an FL client (or another entity in the system) which comprises information to restrict or control which users or entities are able to discover and use the FL client and/or datasets that the FL client is making available. A mechanism may also exists to allow users that the FL client does not know a priori to request authorization to use the dataset and training capabilities of the FL client. In an example, an authorization policy may exist for each dataset the FL client supports. An example of the Authorization Policy is shown in Table 5.

TABLE 5
Authorization Policy

| Informational | |
|---|---|
| Element | Parameter Description |
| Authorized | A list of users or entities that are authorized to |
| Discovery of | discover the FL client and/or the specified FL |
| FL clients | client dataset. |
| Authorized | A list of users or entities that are authorized to |
| Training FL | submit a federated training request using this FL |
| clients | client and/or FL client dataset. |
| Request | For the case where a user has permission to discover |
| Authorization | a FL client and/or a FL client dataset but does not |
| endpoint | have permission to train a machine learning model |
| | using the discovered dataset, a request is issued |
| | to the FL client (or a configured proxy) to request |
| | permission. This can be the same as ‘Callback |
| | endpoint’ described above. |
| Dataset ID | List of one or more identifiers of the dataset that |
| | this policy applies to. |

In an example, the information elements described above can be combined into one or more messages.

The information elements from these messages may be stored in the FL service and may be used for the discovery and selection procedures defined in the following sections. For example, the information elements may be stored within one or more resources resident on the FL service or within a companion service of the FL service (e.g., data storage service). While this FL client registration process is described first in this disclosure, it may not be a requirement that this is the first step of a process that implements these procedures. It may also be possible for an owner of the FL clients to perform a bulk registration of multiple FL clients as part of configuration for federated learning. This bulk registration may comprise a message in which information for multiple FL clients may be batched together within a single registration messages or set of messages.

This section describes a discovery process that allows an FL user to discover FL clients that have datasets that meet the requirements of the type of data required for the machine learning model the FL user wants to train in a federated manner. When the FL user sends a data discovery message, the FL service may search the registered FL client repository to identify FL clients that have data that matches the criteria specified in the FL user's query. The list of FL clients that have matching data may be sent to the FL user or stored by the FL service. Additional search criteria can include capabilities of the client to perform machine learning which can impact a user's decision to use the data available from the client.

In one example, an apparatus may store information associated with an FL client in an FL client repository. The apparatus may receive, from an FL user, a discovery request. The apparatus may search, the FL client repository, for one or more FL clients matching the criteria. The criteria may comprise at least one of: an FL user identifier, a feature name, or one or more computing capabilities. The apparatus may send, to the FL user, a discovery response indicating one or more FL clients matching criteria indicated by the discovery request.

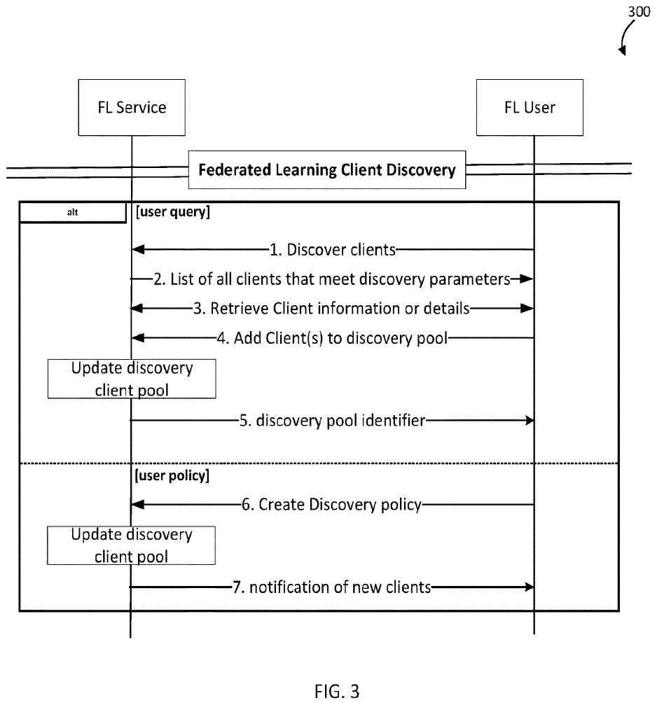

FIG. 3 shows an example FL client discovery procedure 300. At step 1, an FL service may receive an FL client discovery request from an FL user which comprises criteria to specify the type of data and/or capabilities that the FL user requires to train a desired machine learning model. An example of the client discovery criteria is shown in Table 6. The FL user may also include an indication to allow the FL service to create a client discovery policy based on the filter criteria. When the FL service receives this message the FL service may search the registered FL client repository for FL clients that have data and/or capabilities that match the criteria specified in the message. If there are externally connected services the FL service may issue queries to those services as well or use the information stored locally such as, for example, one or more information elements of the registration procedure.

TABLE 6
FL Client Discovery Criteria

| Informational | |
|---|---|
| Element | Parameter Description |
| FL User ID | An identifier of a FL user. Using this ID, the FL |
| | service may verify that the FL user has permission |
| | to discover the data that the FL client has described. |
| Dataset | Search terms that describe attributes or features |
| description | of a dataset. |
| Feature Name | The name of a desired feature or a search expression, |
| | like regular expressions, that may find FL clients |
| | that have features with similar names, properties or |
| | characteristics. |
| FL Client | Identifier of one or more FL clients. The FL user |
| ID list | may have been provisioned with the list of FL clients |
| | by the owner of the FL clients. |
| Training | The scheduled times the FL user is able to execute |
| Time Window | one or more rounds of federated learning. |
| Compute | Aspects of the FL client(s) that are desired by a FL |
| Capabilities | user. For example the operating system, CPU and/or |
| | GPU characteristics. |

At step 2, the FL service may send an FL client discovery response message to the FL user which comprises the results of the FL discovery process. Using the information returned in the response, the FL user may get more details about one or more FL clients meeting the FL user discovery criteria. In an example, to preserve the privacy of the FL clients, the FL service may anonymize the FL client names and/or identifiers, e.g. FL client 1, FL client 2, etc. Within the FL service, a mapping may be created in which the actual FL client name/identifier is mapped to the anonymized FL client names. An example of the FL Discovery Response is shown in Table 7.

TABLE 7
FL Discovery Response

| Informational | |
|---|---|
| Element | Parameter Description |
| Status | The status of the request |
| FL clients | List of FL client identifiers, which may be anonymized |
| | to preserve the privacy of the FL clients. |
| Dataset | A list of dataset(s) that are available on the FL client |
| identifiers | that may fulfill the FL user's requirement for the |
| | machine learning application. |
| Description | For each dataset identifier, a description of the data |
| | may be provided. The description may be the same as the |
| | one provided in the client registration. |

At step 3, the FL service may receive requests from an FL user for more information about the discovered FL clients. The responses from the FL service may comprise one or more information elements such as, for example, one or more information elements of the registration procedure. In some examples, not all information that an FL client provides to an FL service may be provided to the FL user. For example, the specific connection endpoints for the FL clients may not be appropriate to provide to all FL users, e.g., some of this information may be kept private to the FL service.

At step 4, the FL service may receive a request message from an FL user specifying a list of FL clients that meet the requirements of the desired machine learning application of the FL user. The FL service may maintain this list of FL clients in an FL Client Discovery Pool. The discovered FL clients in the pool may match the criteria specified by the FL user or other requirements that the FL user deems sufficient. For example, the FL user may add FL clients to this list that were not provided by the FL service discovery response. In addition, the FL user may send one or more requests to the FL server to add or remove FL client from the FL Client Discovery Pool. An example of the FL Client Discovery pool is shown in Table 8.

TABLE 8
FL Client Discovery pool

| Informational | |
|---|---|
| Element | Parameter Description |
| FL Clients | List of FL client identifiers that are candidates for |
| | selection in a round of federated learning. The FL clients |
| | in this list meet criteria determined by the FL user. |

At step 5, the FL service may send an FL Client Discovery Pool response message to the FL user. The response may comprise an FL Client Pool ID and the FL clients added or removed from the FL Client Discovery Pool. An example of the FL Client Discovery Pool Response is shown in Table 9.

TABLE 9
FL Client Discovery Pool Response

| Informational | |
|---|---|
| Element | Parameter Description |
| Status | The status of the request |
| Discovery | An identifier that is used to uniquely address this list |
| Pool ID | of FL clients that are candidates for selection in a round |
| | of federated learning. |
| FL Clients | Updated list of FL clients that are in the discovery pool |
| | after the modification. |

At step 6, the FL service may receive an FL client discovery policy message from the FL user comprising query parameters (e.g., one or more query parameters defined in Table 6). The FL service may dynamically manage the list/pool of FL clients that match the criteria specified in the Client Discovery Policy as more FL clients register to the FL service after the policy has been created. An example of the FL Client Discovery Policy is shown in Table 10.

TABLE 10
FL Client Discovery Policy

| Informational | |
|---|---|
| Element | Parameter Description |
| Discovery | An identifier that is used to uniquely address this |
| Policy ID | discovery policy. |
| Policy | All of the attributes from the FL client discovery |
| | message, Table 6, may be included in this message, |
| | for the purpose of finding new FL clients or dropping |
| | a FL client that no longer meets the criteria. |
| Notify | Specifies that when there is a change to the FL |
| | clients in the FL client discovery pool, a |
| | notification message may be sent to the FL user (or |
| | specified location). The notification may contain |
| | details of the change or simply indicate that a |
| | change occurred. |

When new FL clients register with the FL service, the information provided by the FL clients may be compared by the FL service with the discovery criteria specified in this policy. If there is a match, then the FL client may be added to the FL client discovery pool. If an FL client changes its registration information (e.g., dataset descriptions) such that it no longer matches this discovery policy, the FL service may remove the FL client from the FL Client Discovery Pool. The FL user may optionally be notified when the list of FL clients in the pool changes.

Creating an FL client discovery policy can be further automated by the FL service. During the processing of an FL client discovery request, the FL service may create a policy based on a filter criteria included in the FL client discovery request. To trigger this, an FL user may include an indication in the FL client discovery request which the FL service uses to qualify creation of the policy.

Step 7 of FIG. 3 may be similar to step 5 of FIG. 3, except that the response is a notification that the FL client discovery pool has been updated. The message contents may be the similar to the information defined in Table 9.

In some examples, an FL user may discover FL clients that meet the FL user specified criteria, defined manually or through the use of a policy. The policy that an FL user defines may also be used in between federated learning rounds to change the selection of FL clients for the next federated learning round. During subsequent federated learning rounds, the schedule of FL clients may change or the available dataset maintained at the FL clients may have been exhausted. As a result, the FL user may need to decide on a new group of FL clients to perform the next round of training. The FL user may perform this interactively or the FL user may define a selection policy to allow the FL service to autonomously make the FL client selection decision on behalf of the FL user.

Once the FL clients are selected, the conventional federated learning process may be started where each FL client is given the model weights of a global model that is the objective of the training process. The FL clients may each train the model locally using the FL client's local data.

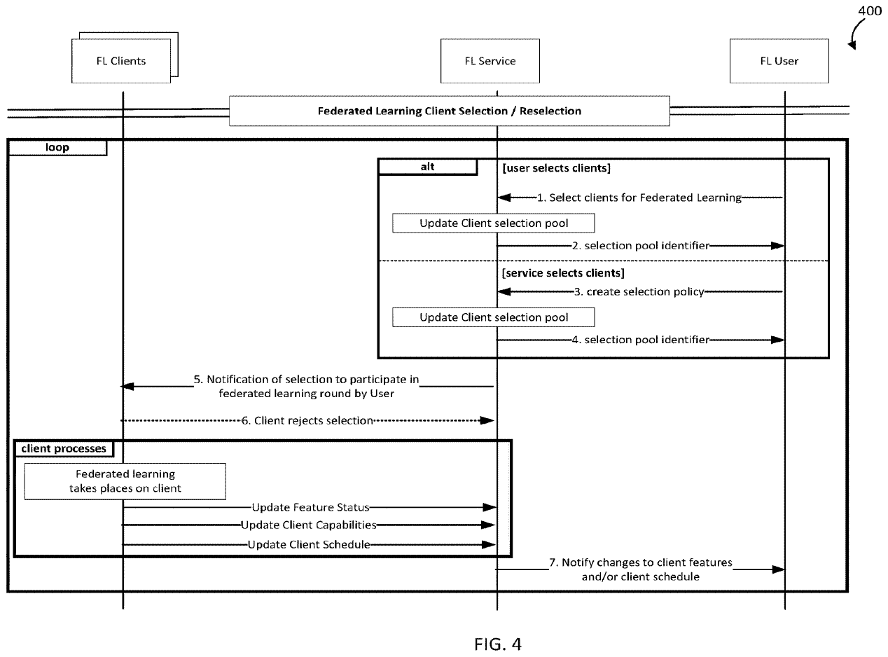

During the period of training or the period since the FL client first registered the data available (e.g., as described regarding FL Client Registration) different aspects of FL client operation may have changed. Some details of the data may have changed or FL client capabilities/availability of processing may have changed. For example, the processing load of the FL client may be high due to high data usage or the FL client data acquisition rate has slowed. These changes may be reported by the FL client to the FL service. FIG. 4 shows an example of FL client selection and reselection procedure.

FIG. 4 shows an example FL client selection procedure 400. At step 1, an FL service may receive a request from an FL user to select FL clients for Federated Learning. An FL user may specify a list of FL clients from a discovery pool ID that should be used to train a machine learning model for a particular federated learning round. The FL clients specified may have been discovered during the previously defined procedures or through other methods. The FL user may optionally specify time constraints for the training process to complete. Table 11 shows an example of informational elements that may be included in the FL client selection message.

TABLE 11
FL Client Selection Message

| Informational | |
|---|---|
| Element | Parameter Description |
| Discovery | An identifier that is used to uniquely address a list of |
| Pool ID | FL clients that are candidates for selection for a |
| | federated learning task. |
| FL clients | List of FL clients that may be included in the FL training. |
| Training | The times that the FL user would like to execute rounds |
| Time Window | of federated learning. This may be used to specify a |
| | deadline for completing the round of training. |

At step 2, the FL service may maintain a list of FL clients that are selected for a round of federated learning training and may assign a Selection Pool ID for the list. If the FL user sends a subsequent FL Client Selection message to the FL service, the list may be modified to add or remove FL clients from the FL client Selection pool. The FL service may send a response to the FL user indicating an identifier for the FL client selection pool as indicated in Table 12.

TABLE 12
FL Client Selection Response

| Informational | |
|---|---|
| Element | Parameter Description |
| Status | The status of the request |
| Selection | An identifier that is used to uniquely address this list |
| Pool ID | of FL clients that are selected for the next round of |
| | federated learning. |
| FL clients | List of FL clients that may be included in the FL training. |

At step 3, the FL service may offer the capability to define a policy for the managed selection of FL clients for federated learning. An FL user may send a message that contains the criteria for the FL service to use in selecting FL clients from the discovery pool for a particular federated learning training round. The FL service may evaluate the policy before a federated learning round is started or it can continuously evaluate the discovery pool to manage the selection pool during subsequent training rounds. An example of the FL Client Selection Policy message is shown in Table 13.

TABLE 13
FL Client Selection Policy message

| Informational | |
|---|---|
| Element | Parameter Description |
| Selection | An identifier that is used to uniquely address this |
| Policy ID | Selection policy. |
| minClients | Minimum number of FL clients required to begin a new |
| | round of training |
| maxClients | Maximum number of FL clients that should be included |
| Selection | When there are more FL clients discovered than the value |
| policy | specified by maxClients this policy may determine how |
| | FL clients may be chosen. This could be based on |
| | priority ordering of the FL client selection criteria, |
| | such as more schedule availability or more instances |
| | of a particular dataset. Alternatively, a selection |
| | rule such as round robin policy may be defined. |
| FL Client | Aspects of the FL client that are desired by a FL user. |
| Characteristics | For example the operating system, CPU or GPU |
| | characteristics. |

Step 4 of FIG. 4 may be similar to step 2 of FIG. 4, except that the response may be a notification that the selection pool has been updated. The message content may be similar to the message in Table 12.

Step 5 of FIG. 4 may include the FL service sending a notification to FL clients of their selection for FL operations. Before federated machine learning rounds can start, FL clients may be sent a notification. The notification may contain information that the FL client has been selected to participate in the federated learning process. This information may include federated learning specific information, such as how to communicate with the federated learning service or orchestrator. It may also include information about the FL user that has selected the FL client. An example of the FL client selection notification message is shown in Table 14.

TABLE 14
FL client selection notification message

| Informational | |
|---|---|
| Element | Parameter Description |
| Selection | An identifier that is used to uniquely address this list |
| Pool ID | of FL clients that are selected for the next round of |
| | federated learning. |
| FL User ID | The identifier of the FL user that has selected the FL |
| | client for training. The FL client may use this for |
| | authorization purposes or accessing relevant information |
| | about the FL user. |
| Federate | Information that the FL client has been selected to |
| Machine | participate in the federated machine learning round. |
| Learning | This may include control information such as the |
| configuration | scheduled time constraints, connection information |
| | for the federated learning aggregation service, etc. |

This notification can be a message sent directly to the FL client.

Step 6 of FIG. 4 may include an FL client rejection message. The FL service may enable FL clients that is providing data to an FL user for training a machine learning model the ability to reject participation in a round of training. A response from the FL client may include a rejection due to FL user permissions or other FL client reasons, such as no capacity to perform training at this time. The response may also indicate to the FL service to remove the FL client from the selection pool. An example of the Selection rejection message is shown in Table 15.

TABLE 15
Selection rejection message

| Informational | |
|---|---|
| Element | Parameter Description |
| Selection | An identifier that is used to uniquely address this |
| Pool ID | list of FL clients that are selected for the next |
| | round of federated learning. |
| Result | The client sends a response indicating the acceptance or |
| | rejection to participate in the round of training. |
| Reason | The FL client may provide a reason for the rejection. |
| | The FL service may use this reason as criteria for |
| | future selections, for example it may maintain a |
| | rejection List of FL users that may not be accepted. |
| Remove | An indicator may be provided by the FL client to |
| from pool | inform the FL service to remove the client from the |
| indicator | client selection pool. |

FL Client Processes: After the FL clients have been notified of selection in the federated learning training round along with the configuration details, the federated learning round may begin. This process may use any existing federated learning frameworks to orchestrate the machine learning between the FL clients and the aggregation FL service. While the federated machine learning rounds are executed, the FL clients may update the FL service with information that the FL clients had provided during the FL client registration process. These updates may result in modifications to the FL client discovery pool and/or the FL client selection pool that may result in notifications sent to the FL user of changes. These updates may use, for example, the messages defined in relation to FL Client Registration.

At step 7, the FL service may notify the FL user of changes to the FL client information. If the FL user had created an FL client discovery policy, then updates provided by FL clients may be monitored by the FL service and if the modified criteria no longer matches, then the FL client may be removed from the discovery pool.

If the FL user had created an FL client selection policy, then the updates provided by the FL clients may be monitored by the FL service and if the modified criteria no longer matches, then the FL client may be removed from the selection pool.

New FL clients registering or updates from existing FL clients that are not part of the current discovery and selection pools may also be monitored. If the FL user had defined polices matching the new criteria from these FL clients, then these FL clients may be added to the discovery and/or selection pool.

The notifications of changes that are sent to the FL user based on the user created policies may be similar to the messages defined in Table 9 and Table 12.

An example of the disclosure based on RESTful services may have resources that represent the FL clients, the shared data, their available compute capabilities for FL training, and their scheduled availability, e.g., as described Regarding FL Client Registration. Additional resources may be used to represent the FL users and the selection and discovery policies that they create.

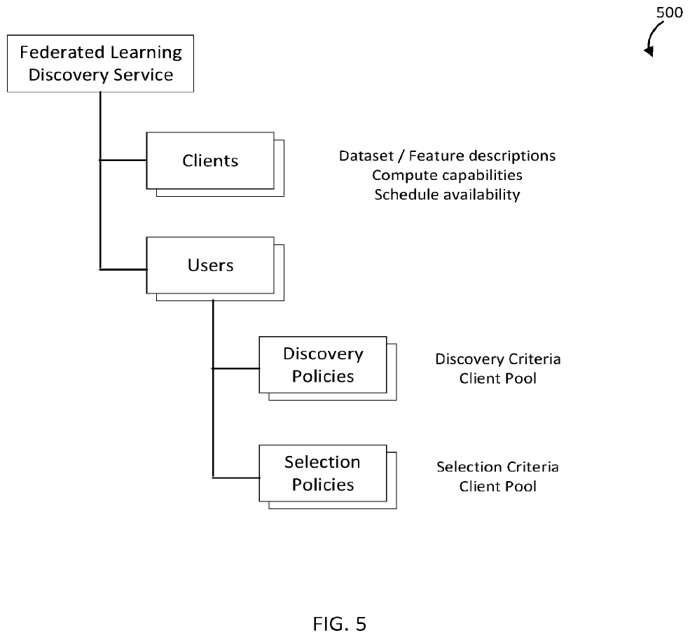

FIG. 5 shows an example of a RESTful example of Federate Learning Discovery Service 500.

According to a basic example scenario, several FL clients may register with the FL Service and an FL user may discover and select FL clients that have the data needed to train a machine learning model.

There may be three “FL clients” that register in this example:
FL client #1 represents a group of smart city traffic light cameras;
FL client #2 represents a group of toll booth traffic cameras; and
FL client #3 represents a group of doorbell security cameras.

The “FL user” in this example requires images of vehicles to train a machine learning model.

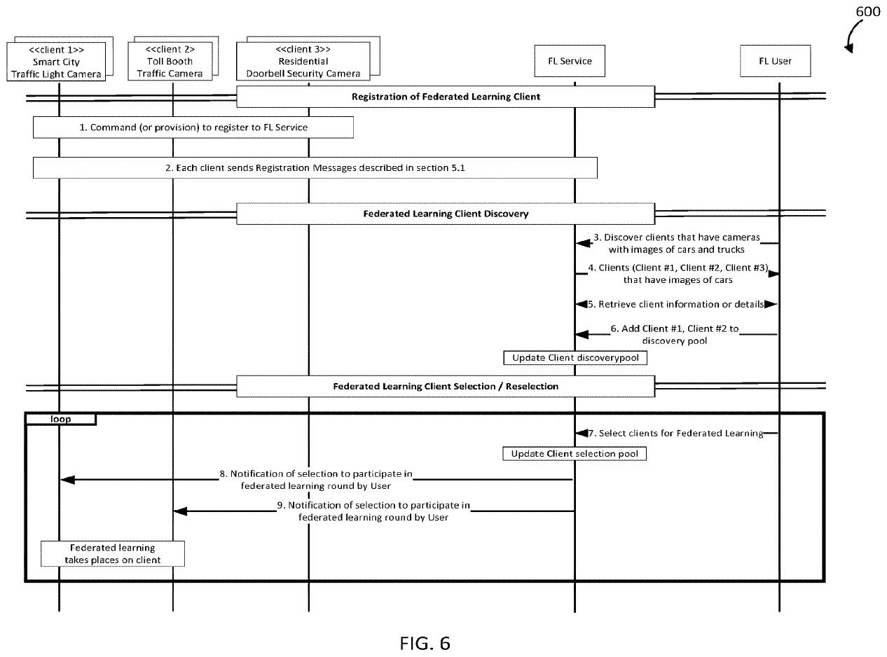

FIG. 6 shows an example FL client registration and discovery procedure 600. As illustrated in Step 1 of FIG. 6, FL clients may be triggered or commanded to register to the FL service.

As illustrated in Step 2 of FIG. 6, FL client registration messages may be sent by each FL client that has data and is making the data available for training of machine learning models (e.g., examples of these messages using the scenario described are shown below). The messages may be grouped for the purpose of describing them, but each FL client may send these messages independently of other FL clients and grouping in this manner is not required.

Step 2.1 of FIG. 6 may include an FL Client Connection Message. The FL client connection message may be defined as shown in Table 1. The FL Client Connection Message may be implemented using https and JSON as shown in Table 16. This message is only shown for “FL client1”, but all of the FL clients would send this message with the payload modified accordingly.

TABLE 16
FL client 1 registration message

```
POST /v1.0/{company_name}/clients
Content type: application/json
PAYLOAD
{
  “clientid”: “client1”,
  “callback”:”https://172.25.0.23:8080/local-events”
}
```

Step 2.2 of FIG. 6 may include an FL Client Feature Registration Message. The FL client feature message (e.g., defined in Table 2) is for each FL client to describe the type of data that it is making available for training machine learning models.

For example, the message from FL client #1 describes the images that are captured throughout a city where traffic lights are equipped with cameras.

```
POST /v1.0/{company_name}/client1/features
Content type: application/json
PAYLOAD
{
  “features”: [
    {
      “name”: “traffic”,
      “description”: {
          “images from traffic cameras at intersection 1^{st} and main st”,
          “cars, trucks, motorcycles”
        },
    “format” :{
        “resolution”:”1080x780”
        “colors”:”8bit”
        },
    “metadata”:{
        “distance”:”50ft”
        },
    “featureID”:”camImage”
    “RelatedFeatures”:[“timestamp”,”location”,”direction”],
    “DataCount”: 130983,
    “sampleData”:”http://my-private_data/public-acess/sample1”
    },
    { ... }
}
```

The message from FL client #2 describes the images that are captured on a toll road where the toll booths are equipped with cameras.

```
POST /v1.0/{company_name}/client2/features
Content type: application/json
PAYLOAD
{
  “features”: [
    {
      “name”: “traffic”,
      “description”: {
          “images from toll booth camera at marker 326”,
          “cars, trucks, motorcycles”
        },
    “format” :{
        “resolution”:”1080x780”
        “colors”:”8bit”
        },
    “metadata”:{
        “distance”:”50ft”
        },
    “featureID”:”camImage”
    “RelatedFeatures”:[“timestamp”,”location”,”direction”],
    “DataCount”: 130983,
    “sampleData”:”http://my-private_data/public-acess/sample1”
    },
    { ... }
}
```

The message from FL client #3 describes the images that are captured from doorbell cameras on residential or commercial buildings.

```
POST /v1.0/{company_name}/client3/features
Content type: application/json
PAYLOAD
{
  “features”: [
    {
      “name”: “frontDoor”,
      “description”: {
          “images from doorbell cameras”,
          “cars, pedestrians”
        },
    “featureID”:”images”
    “RelatedFeatures”:[“timestamp”],
    “DataCount”: 13050,
    “sampleData”:”http://my-private-data/public-access/sample1”
    },
    { ... }
}
```

Step 2.3 of FIG. 6 may include an FL Client Compute Capabilities Message. The FL client compute capabilities message is for each FL client to describe the type of compute resources that it is making available for training machine learning models. This message is only shown for “FL client1”, but all of the FL clients would send this message with the payload modified accordingly.

```
POST /v1.0/{company_name}/{ClientID}/computeCapabilities
Content type: application/json
PAYLOAD
{
  “compute”:{
      “OS”: “ubuntu”,
      “cpu”: {
        “processor”:“ARM Cortex-A72”,
        “clock”:”1.5GHz”,
        “cores”:4,
        },
    “scripting”:{“python”, ”dockercontainer”},
    }
}
```

Step 3 of FIG. 6 may include an FL Client Discovery request. The FL client specifies the features and characteristics of the data that is required to train the machine learning model. The FL user can also specify the compute capabilities that the FL client should have available for training.

```
GET /v1.0/{company_name}/clients
Content type: application/json
PAYLOAD
{
  “feature”:{
      “description”: [“car”, “truck”],
    }
  “compute”:{
    “scripting”:{“python” },
    }
}
```

Step 4 of FIG. 6 may include an FL Client Discovery response. The FL service searches through the registered FL clients to find FL clients that have features that match the features in the discovery request. For this scenario, the FL service identifies FL client #1 and FL client #2 having the image types requested.

```
{
  ″body″: {
    ″count″: 2
“clients”: [“client1”,”client2”]
  },
  ″head″: {
    ″errors″: [ ],
    ″messages″: [ ],
    ″ok″: true,
    ″status″: 200
  }
}
```

Step 5 of FIG. 6 may include an FL client request. The FL user can access additional details about the FL clients that matched the discovery request by issuing the appropriate GET requests.

Step 6 of FIG. 6 may include an FL Client Discovery Pool request. The FL user specifies which FL clients that were discovered can be used for training the machine learning model. In this example {UserID} is used to distinguish Model developers (“FL users”) and FL clients that make data available (“FL clients”). However an alternate example may use the same key to represent registered customers of the FL service.

POST /v1.0/{company_name}/{UserID}/discoveryPool
Content type: application/json
PAYLOAD
{
“clients”:[“client1”,”client2”]
}

Step 7 of FIG. 6 may include an FL Client Selection request. When an FL user determines that a Federated learning model can be trained it sends an FL client selection request. The FL client selection request contains a list of FL clients that should be used for the round of Federated learning. The list can be a subset of the FL clients in the discovery pool or it can contain all of the FL clients in the discovery pool.

POST /v1.0/{company_name}/{UserID}/selectionPool
Content type: application/json
PAYLOAD
{
“clients”:[“client1”,”client2”]
}

Step 8 and Step 9 of FIG. 6 may include an FL Client Selection Notification. When an FL user selects an FL client, the FL Service notifies each FL client. The notification includes the UserID so that the FL client can accept or reject the reject the request. The notification also includes the information needed to perform the round of federated learning. This may include the configuration parameters of an aggregation FL service that manages the federated learning process.

```
POST /{callback-endpoint}/fedmlClientSelection
Content type: application/json
PAYLOAD
{
  “selectionPoolId”: “selectionID”,
  “userID”:”user_ID”,
  “configuration”:{
    “federatedLearningServer”:https://some server ip address:port,
    “authToken”:”token,
    },
}
```

Depending on the Federated Learning Framework communication protocols, the FL client may register to the “federatedLearningServer”, as shown in this example, or the FL service may connect to the FL client (not shown). At that point the Federated learning process takes place using the FL client data and FL client compute resources that were discovered and configured using the method defined in this disclosure.

This example demonstrates preprovisioning, an FL process that extends the previous discovery process described in regarding FL Client Registration and Discovery. The FL user may configure a specific FL client, known a priori to the FL user, that was not discovered and may not even be registered to the FL service at the time when the FL user configures the FL client selection.

Three “FL clients” register (e.g., similar to the previous example).
FL client #1 represents a group of smart city traffic light cameras
FL client #2 represents a group of toll booth traffic cameras
FL client #3 represents a group of doorbell security cameras

A fourth FL client registers after the FL user sends the FL client selection message. The FL user is already aware of the FL client ID for the new FL client.

FL client #4 represents parking lot/garage security cameras

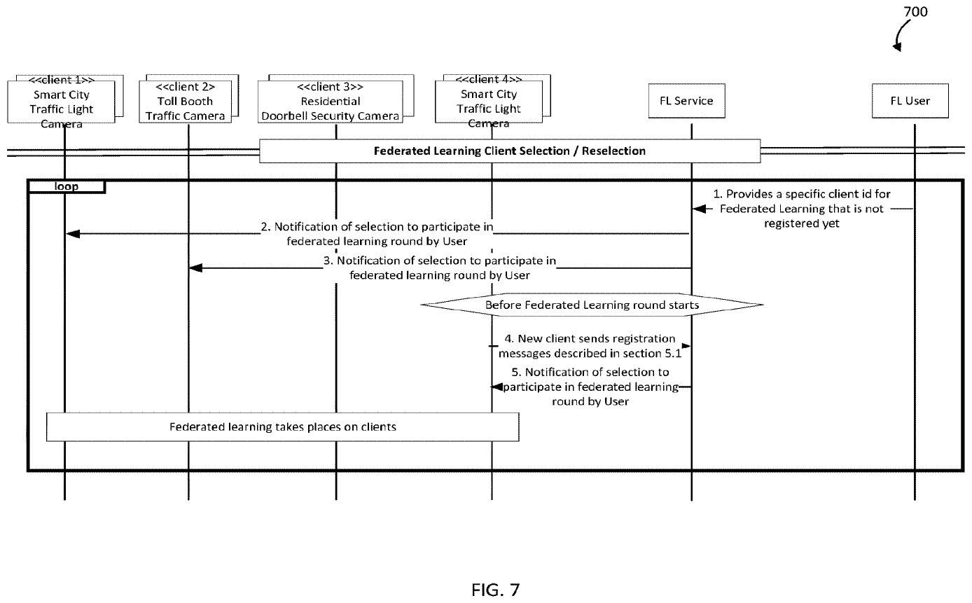

FIG. 7 illustrates an example 700 of FL Client Provisioning with FL Client known a priori. Step 1 of FIG. 7 may include an FL Client Selection request. The FL user has already discovered the FL clients that have data that is needed for a machine learning model that is to be trained. In addition to the discovered sources of data, another known FL client, FL client #4, is also going to participate in the federated learning training round.

The FL client selection request contains a list of FL clients that may be used for the round of Federated learning. The list may include FL clients that are not from the discovery pool. In this example, FL client #4 registers after the FL Client Selection request is sent and the FL service is monitoring new FL client registrations.

As illustrated in Step 2 and Step 3 of FIG. 7, the FL client selection notification messages are the same as shown in step 8 and step 9 (e.g., as described regarding FL Client Registration and Discovery).

Step 4 of FIG. 7 may include FL client registration messages. When FL client #4 registers to the FL service it may send all of the registration messages (e.g., as described regarding FL Client Registration), however since discovery is not required in the case that the FL user is aware of the FL client a priori, the only message that is required is from Table 1. This message may be similar to the message shown in Table 16.

As illustrated in Step 5 of FIG. 7, the FL client selection notification messages may be the same as shown in step 8 and step 9 (e.g., as described regarding FL Client Registration and Discovery).

This example demonstrates dynamic discovery and selection of FL clients for a federated learning process that extends the discovery process. The FL user configures a discovery policy and a selection policy. As new FL clients register, the conditions for the selection policy are met and the process continues. In this example the selection policy is specified to require a minimum of three FL clients.

Initially there are three “FL clients” that registered.
FL client #1 represents a group of smart city traffic light cameras.
FL client #2 represents a group of toll booth traffic cameras.
FL client #3 represents a group of doorbell security cameras.

Later a fourth FL clients registers after the FL user sends the FL client discovery and selection messages. FL service.

FL client #4 represents parking lot/garage security cameras.

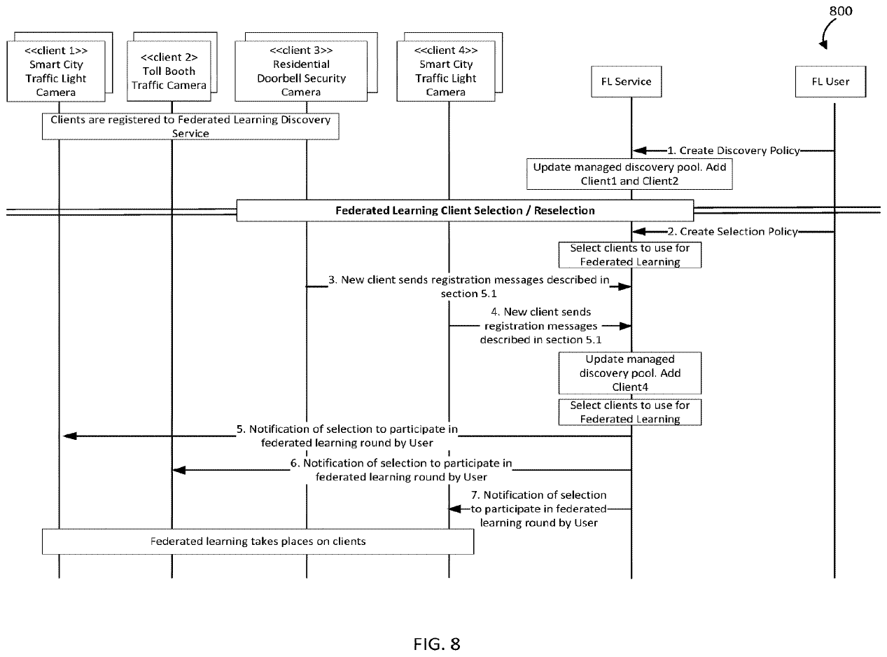

FIG. 8 illustrates an example 800 of use of Discovery and Selection policies.

As illustrated in Step 1 of FIG. 8, the FL Client Registration occurs as described regarding FL Client Registration and Discovery, step 1 and step 2 (e.g., including 2.1, 2.2, 2.3).

As illustrated in Step 2 of FIG. 8, the AN FL user creates a Discovery Policy (e.g., as described in Table 10). The message is similar to the discovery request message.

```
POST /v1.0/{company_name}/discoveries
Content type: application/json
PAYLOAD
{
  “discoveryPolicyID”:”discovery_policy_id”,
  “policy”: {
    “feature”:{
        “description”: [“car”, “truck”],
          }
      }
}
```

When this message is received the FL service searches through the registered FL clients to find FL clients that have features that match the features in the discovery policy. For this scenario, the FL service identifies FL client #1 and FL client #2 having the image types requested.

As illustrated in Step 3 of FIG. 8, an FL user creates a Selection Policy (e.g., as described in Table 13). In this example the selection policy is configured to require at least 3 FL clients from the discovery pool.

```
POST /v1.0/{company_name}/selections
Content type: application/json
PAYLOAD
{
  “selectionPolicyID”:”selection_policy_id”,
  “minClients”: 3
}
```

When this message is received the FL service searches through the discovery pool to find FL clients that have features that match the conditions or features in the discovery policy. For this scenario, the FL service adds all of the FL clients from the discovery pool to the selection pool. In the case there are two FL clients added, FL client #1 and FL client #2. Since this policy specifies a minimum of three FL clients, the FL service does not send notifications to the FL clients.

As illustrated in Step 4 of FIG. 8, FL client #4 registers as described regarding FL Client Registration and Discovery, step 1 and step 2 (including 2.1, 2.2, 2.3).

When FL client #4 registers, the FL service checks the discovery and selection policies. In this example FL client #4 matches the discovery policy and is added to the discovery pool. The FL service also adds FL client #4 to the selection pool. The selection pool now contains three FL clients which meets the policy conditions.

As illustrated in Step 5, Step 6, and Step 7 of FIG. 8, the FL client selection notification messages is the same as shown in step 8 and step 9 (e.g., as described regarding FL Client Registration and Discovery).

In federated machine learning the data being used for machine learning belongs to the FL client. In some examples, the FL client may be provided with the method to reject the participation of a round of training for an FL user. This example shows an FL client is selected by an FL user for a round of federated learning but the FL client does not accept the request.

The scenario is the same as shown in FIG. 6.

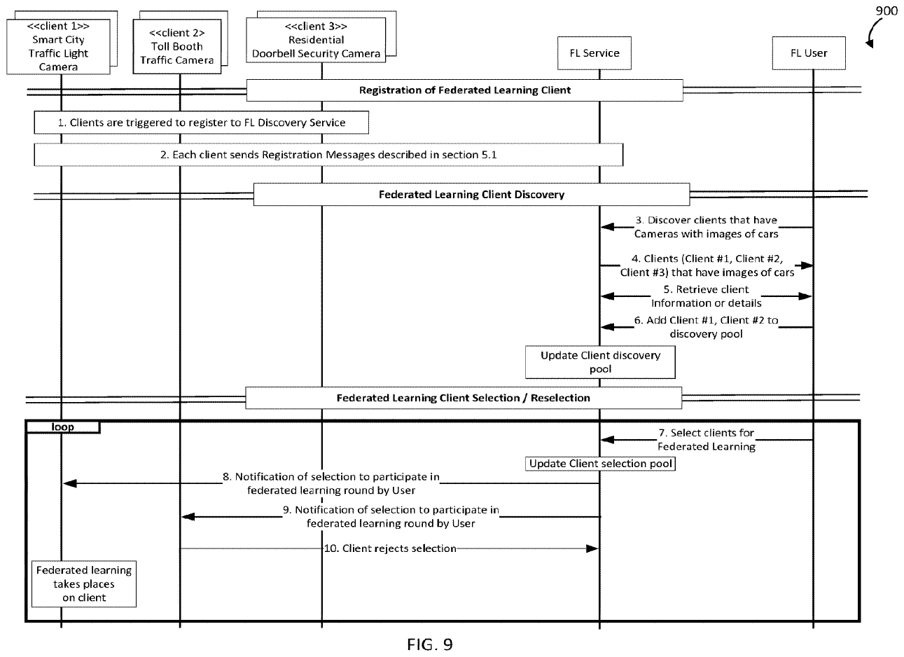

FIG. 9 illustrates an example 900 of an FL client can reject participation in Federated Learning.

Steps 1 through 9 of FIG. 9 may be the same as shown in FIG. 6.

As illustrated in Step 10 of FIG. 9, FL client #2 receives the notification of selection and determines that it may not participate in this round of federated learning. FL client #2 sends a response to the selection notification indicating that the request is rejected.

```
{
  ″body″: {
      “selectionPolicyID”:”selection_policy_id”,
    “reason”: “use of data not granted”
  },
  ″head″: {
    ″errors″: [ ],
    ″messages″: [ ],
    ″ok″: false,
    ″status″: 400
  }
}
```

This section shows a potential graphical FL user interface based example of the methods disclosed in this paper. First the regististration of FL clients is shown and then discovery of FL clients by an FL user.

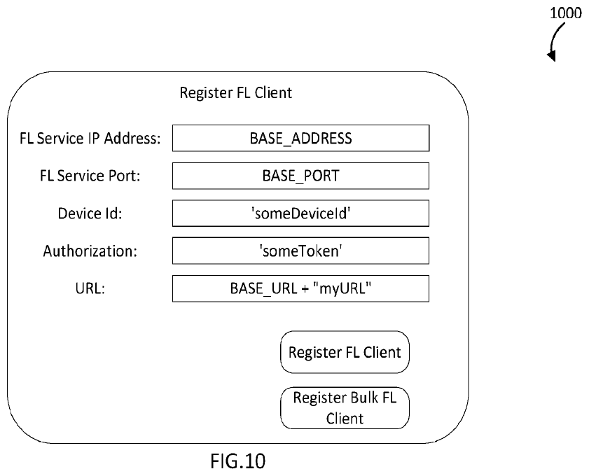

The registration of FL clients is described and illustrated regarding FIG. 2, including procedures and information elements of messages. In some examples, FIGS. 10-12 show user interfaces of those procedures. These are shown as a single graphic user interface for each message, but information elements may be combined into a single graphic user interface that represents several messages (e.g., as described in association with FIG. 2).

FIG. 10 illustrates an example of an FL Client Registration GUI 1000.

FIG. 11 illustrates an example of a Feature Registration GUI 1100.

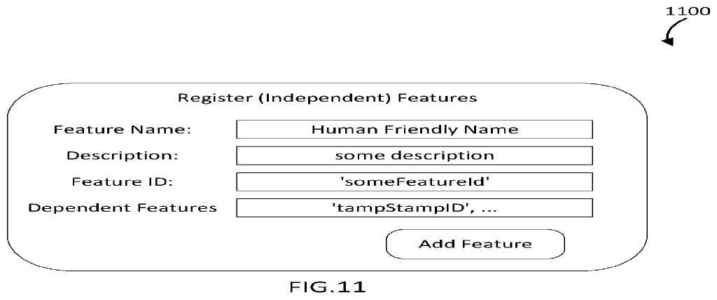

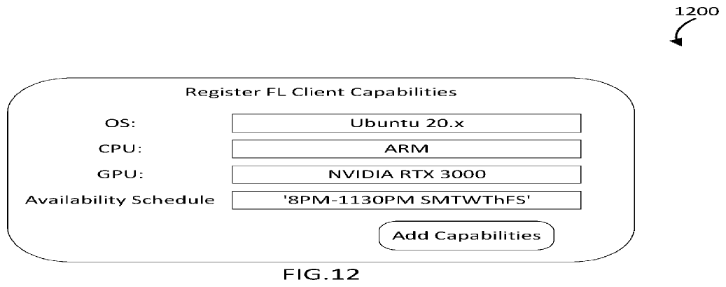

FIG. 12 illustrates an example of a Compute Capabilities Registration GUI 1200.

In some examples, the discovery and selection of FL clients is described (e.g., as described regarding FL Client Discovery and FL Client Selection and Reselection), including procedures and information elements of messages.

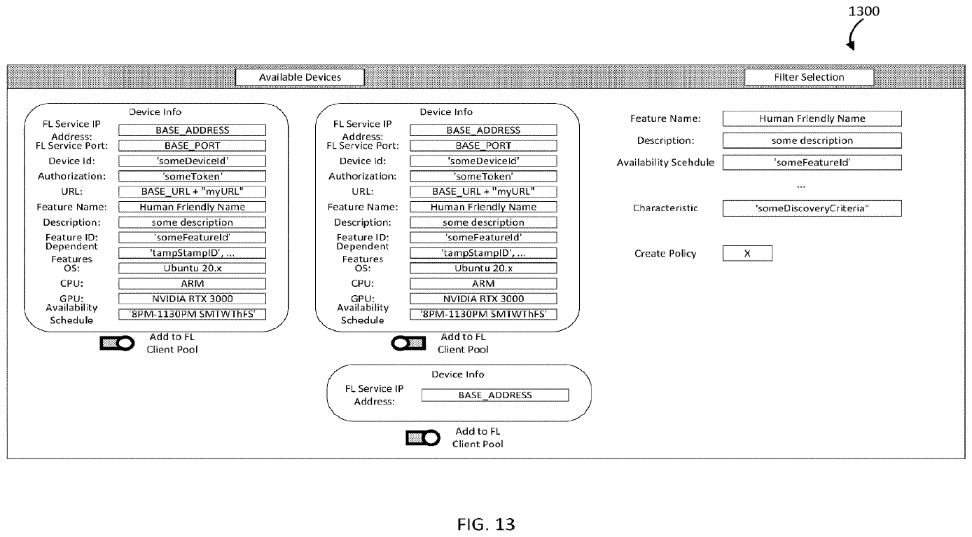

FIG. 13 illustrates an example user interface of those procedures 1300 (e.g., FL Client Discovery and Selection GUI). Although FIG. 13 may illustrate a single graphic user interface for several messages, information elements may be combined or separated such that multiple graphic user interfaces are used to represent the messages (e.g., as described regarding FL Client Discovery and FL Client Selection and Reselection).

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that may provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

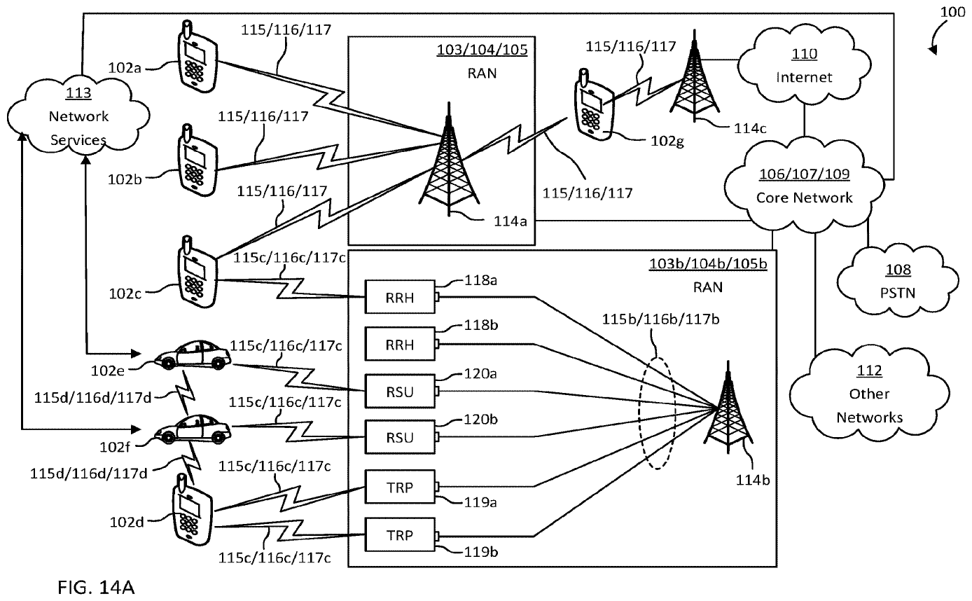

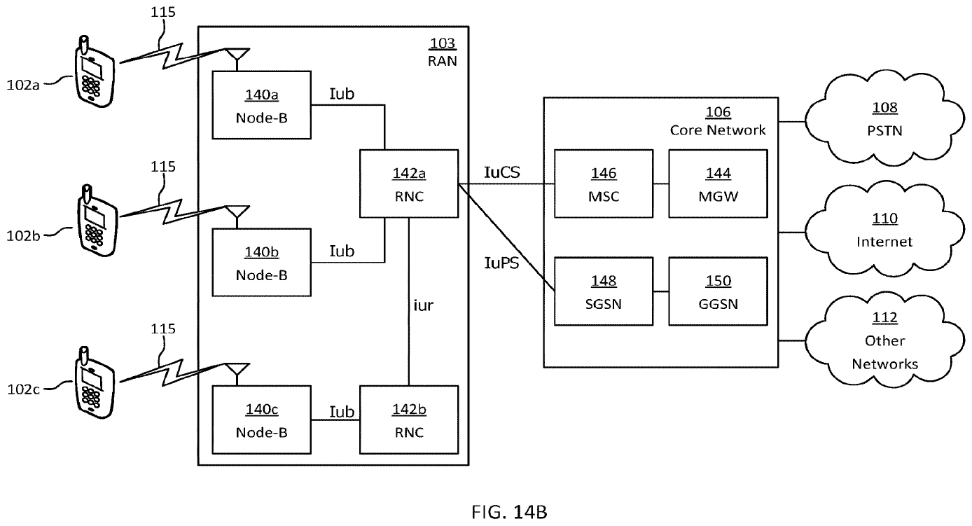

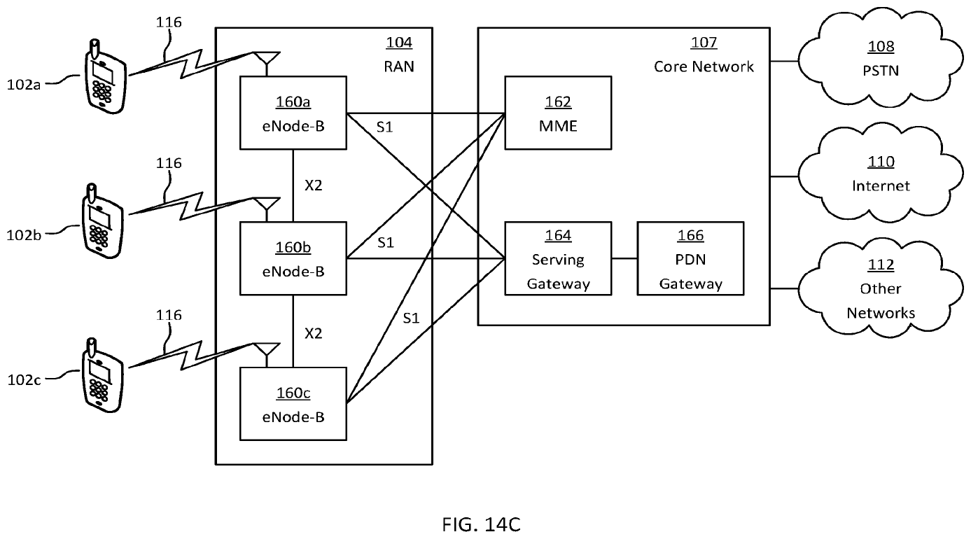

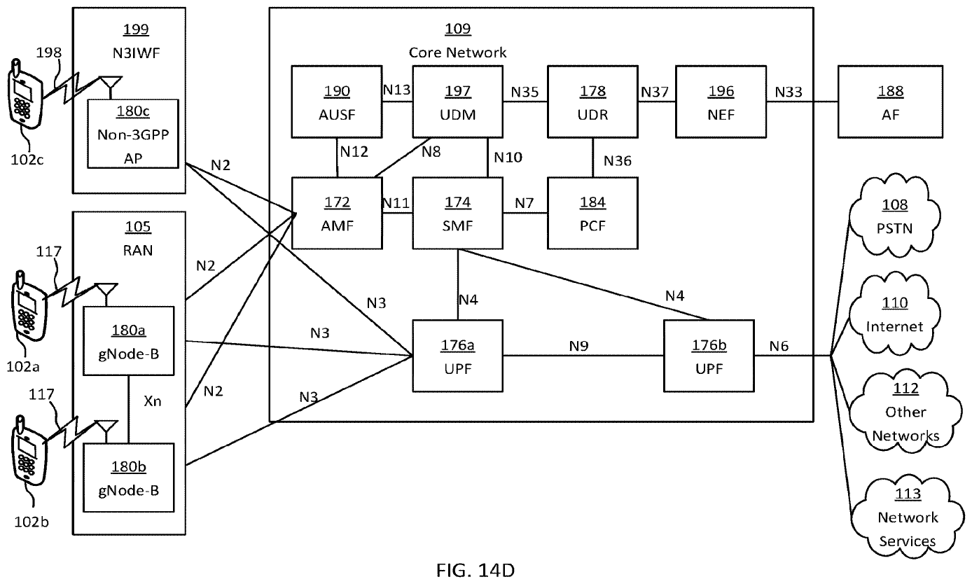

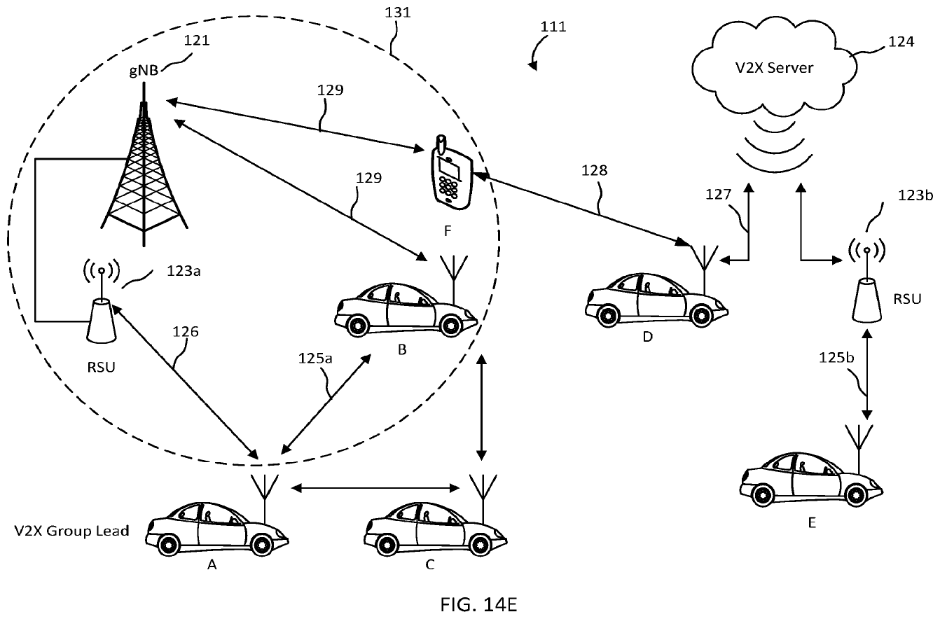

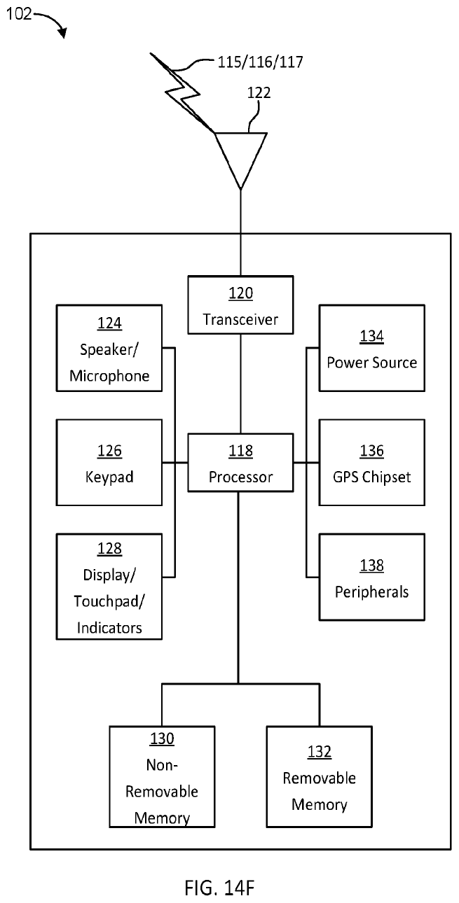

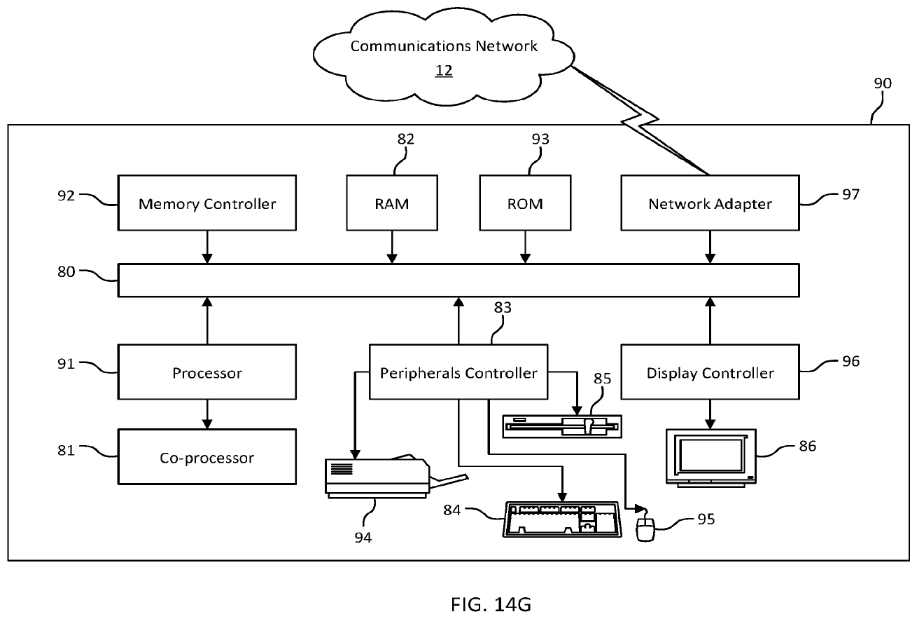

FIG. 14A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It may be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 14A, each of the WTRUs 102 is depicted in FIGS. 14A-14E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include abase station 114a and abase station 114b. In the example of FIG. 14A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 14A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 14A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 14A, it may be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 14A may be configured to communicate with the base station 114a, which may employ a cellular-based radio technology, and with the base station 114c, which may employ an IEEE 802 radio technology.

Although not shown in FIG. 14A, it may be appreciated that a User Equipment may make a wired connection to a gateway. The gateway maybe a Residential Gateway (RG). The RG may provide connectivity to a Core Network 106/107/109. It may be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 14B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 14B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It may be appreciated that the RAN 103 may include any number of Node-Bs and Radio Network Controllers (RNCs.)

As shown in FIG. 14B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142aand 142b may be configured to control the respective Node-Bs 140a, 140b, and 140c to which it is connected. In addition, each of the RNCs 142aand 142b may be configured to carry out or support other functionality, such as outer loop power control, load control, admission control, packet scheduling, handover control, macro-diversity, security functions, data encryption, and the like.

The core network 106 shown in FIG. 14B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it may be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 14C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it may be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 14C, the eNode-Bs 160a, 160b, and 160c may communicate with one another over an X2 interface.

The core network 107 shown in FIG. 14C may include a Mobility Management Gateway (MME) 162, a serving gateway 164, and a Packet Data Network (PDN) gateway 166. While each of the foregoing elements are depicted as part of the core network 107, it may be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 14D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It may be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It may also be appreciated the RAN 105 may employ more than one type of base station. For example, the RAN may employ eNode-Bs and gNode-Bs.

The N3IWF 199 may include a non-3GPP Access Point 180c. It may be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 14D, the gNode-Bs 180a and 180b may communicate with one another over an Xn interface, for example.

The core network 109 shown in FIG. 14D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 14G.

In the example of FIG. 14D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it may be appreciated that any one of these elements may be owned and/or operated by an entity other than the core network operator. It may also be appreciated that a 5G core network may not consist of all of these elements, may consist of additional elements, and may consist of multiple instances of each of these elements. FIG. 14D shows that network functions directly connect to one another, however, it should be appreciated that they may communicate via routing agents such as a diameter routing agent or message buses.

In the example of FIG. 14D, connectivity between network functions is achieved via a set of interfaces, or reference points. It may be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 14D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 14D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function may add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that may be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators may use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 14D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 14A, 14C, 14D, and 14E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 14A, 14B, 14C, 14D, and 14E are provided by way of example only, and it is understood that the subject matter disclosed and claimed herein may be embodied or implemented in any similar communication system, whether presently defined or defined in the future.

FIG. 14E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 14E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 14E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 14F is a block diagram of an example apparatus or device WTRU 102 that may be configured for wireless communications and operations in accordance with the systems, methods, and apparatuses described herein, such as a WTRU 102 of FIG. 14A, 14B, 14C, 14D, or 14E. As shown in FIG. 14F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It may be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 14F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 14F depicts the processor 118 and the transceiver 120 as separate components, it may be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 14A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It may be appreciated that the transmit/receive element 122 may be configured to transmit and/or receive any combination of wireless or wired signals.

In addition, although the transmit/receive element 122 is depicted in FIG. 14F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It may be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 14G is a block diagram of an exemplary computing system 90 in which one or more apparatuses of the communications networks illustrated in FIGS. 14A, 14C, 14D and 14E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that may not easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 14A, 14B, 14C, 14D, and 14E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

What is claimed is:

1.-20. (canceled)

21. An apparatus comprising:
a processor configured to:
receive, from a federated learning (FL) client, one or more messages requesting to register with an FL service, the one or more messages indicating an availability of one or more datasets, an indication of one or more services supported by the FL client, a location information associated with the FL client, one or more processing capabilities associated with the FL client, one or more machine learning capabilities associated with the FL client, and an availability schedule of the FL client;
receive, from a FL user, a request to use at least one FL client for a task, wherein one or more FL client selection criteria are indicated by the FL user in the request;
select a set of one or more FL clients based on the FL client selection criteria and assign a pool ID to the set of one or more FL clients;
send, to the FL user, a response comprising an indication of the set of one or more FL clients and the pool ID; and
send, to the set of one or more FL clients, a selection notification comprising federated machine learning configuration information and an indication of the pool ID.

22. The apparatus of claim 21, wherein the processor is configured to:
receive updated registration information from a first FL client;
add the first FL client to the set of one or more FL clients corresponding to the pool ID based on the update registration information; and
send, to the FL user, an indication that the first FL client has been added to the set of one or more FL clients corresponding to the pool ID.

23. The apparatus of claim 21, wherein the processor is configured to:
receive, from the FL user, a discovery request to discover at least one FL client that has a dataset available for training a machine learning (ML) model, the discovery request comprising an indication of requested computation capabilities of the at least one FL client and a data type indication associated with the dataset for training the ML model; and
send, to the FL user, a discovery response comprising a list of FL client identifiers associated with one or more FL clients, the list of FL client identifiers being sent in response to the discovery request.

24. The apparatus of claim 21, wherein the one or more messages further indicates an operating system, a processing script capability, or one or more communication protocols.

25. The apparatus of claim 21, wherein the one or more messages further indicates one or more dataset types, a dataset provider, an application identifier, a dataset description, a target feature, a label description, a format, metadata, or sample data.

26. The apparatus of claim 21, wherein the one or more processing capabilities comprises a type of central processing unit (CPU) used for FL training, a type of graphical processing unit (GPU) used for FL training, or an amount of memory available for FL training.

27. The apparatus of claim 21, wherein the FL client selection criteria comprise schedule availability or instances of a particular dataset.

28. The apparatus of claim 21, wherein the federated machine learning configuration information comprises information that the FL client has been selected to participate in a federated machine learning round.

29. The apparatus of claim 28, wherein the information comprises control information, and wherein the control information comprises scheduled time constraints and connection information for a federated learning aggregation service.

30. The apparatus of claim 21, wherein the pool ID comprises an identifier that is used to address a list of FL clients that are selected for a next round of federated learning.

31. A method performed by an apparatus, the method comprising:
receiving, from a federated learning (FL) client, one or more messages requesting to register with an FL service, the one or more messages indicating an availability of one or more datasets, an indication of one or more services supported by the FL client, a location information associated with the FL client, one or more processing capabilities associated with the FL client, one or more machine learning capabilities associated with the FL client, and an availability schedule of the FL client;
receiving, from a FL user, a request to use at least one FL client for a task, wherein one or more FL client selection criteria are indicated by the FL user in the request;
selecting a set of one or more FL clients based on the FL client selection criteria and assign a pool ID to the set of one or more FL clients;
sending, to the FL user, a response comprising an indication of the set of one or more FL clients and the pool ID; and
sending, to the set of one or more FL clients, a selection notification comprising federated machine learning configuration information and an indication of the pool ID.

32. The method of claim 31, wherein the method further comprises:
receiving updated registration information from a first FL client;
adding the first FL client to the set of one or more FL clients corresponding to the pool ID based on the update registration information; and
sending, to the FL user, an indication that the first FL client has been added to the set of one or more FL clients corresponding to the pool ID.

33. The method of claim 31, wherein the method further comprises:
receiving, from the FL user, a discovery request to discover at least one FL client that has a dataset available for training a machine learning (ML) model, the discovery request comprising an indication of requested computation capabilities of the at least one FL client and a data type indication associated with the dataset for training the ML model; and
sending, to the FL user, a discovery response comprising a list of FL client identifiers associated with one or more FL clients, the list of FL client identifiers being sent in response to the discovery request.

34. The method of claim 31, wherein the one or more messages further indicates an operating system, a processing script capability, or one or more communication protocols.

35. The method of claim 31, wherein the one or more messages further indicates one or more dataset types, a dataset provider, an application identifier, a dataset description, a target feature, a label description, a format, metadata, or sample data.

36. The method of claim 31, wherein the one or more processing capabilities comprises a type of central processing unit (CPU) used for FL training, a type of graphical processing unit (GPU) used for FL training, or an amount of memory available for FL training.

37. The method of claim 31, wherein the FL client selection criteria comprise schedule availability or instances of a particular dataset.

38. The method of claim 31, wherein the federated machine learning configuration information comprises information that the FL client has been selected to participate in a federated machine learning round.

39. The method of claim 38, wherein the information comprises control information, and wherein the control information comprises scheduled time constraints and connection information for a federated learning aggregation service.

40. The method of claim 31, wherein the pool ID comprises an identifier that is used to address a list of FL clients that are selected for a next round of federated learning.
